(19) United States
(12) Patent Application Publication
(10) Pub. No.: US 2018/0229478 A1
(43) Pub. Date: Aug. 16, 2018

(54) THERMAL LAMINATE MATERIAL AND A METHOD OF MAKING THE SAME

(71) Applicant: ADA Technologies, Inc., Littleton, CO (US)

(72) Inventors: Thierry Carriere, Littleton, CO (US); Mike Tomlinson, Littleton, CO (US); Mitchell Hageman, Monument, CO (US)

(21) Appl. No.: 15/454,838

(22) Filed: Mar. 9, 2017

Related U.S. Application Data
(60) Provisional application No. 62/305,882, filed on Mar. 9, 2016.

(51) Int. Cl. B32B 17/10; B32B 7/02; B32B 7/12; B32B 15/02; B32B 18/00; B32B 37/12

(52) U.S. Cl. CPC B32B 17/10311; B32B 7/02; B32B 7/12; B32B 15/02; B32B 2315/02; B32B 37/12; B32B 2262/105; B32B 2307/30; B32B 2311/24; B32B 18/00

(57) ABSTRACT

The patent application relates generally to a thermal laminate material, more particularly to thermal material comprising at least an intumescent layer and a refractory layer. The intumescent layer and refractory layer are generally stacked one-on-top of the other. The thermal laminate material can include a reinforcement material. The reinforcement material can be a metallic material in the form of sheet or mesh. The intumescent layer can contain one of the metallic sheet reinforcement material or the metallic mesh. The refractory layer can be a ceramic. Moreover, the refractory layer can be a ceramic fiber-based refractory material. The ceramic fiber-based refractory material can be in the form of paper or felt.

### CROSS REFERENCE TO RELATED APPLICATIONS

The present application claims priority under 35 U.S.C. § 119 to U.S. Provisional Patent Application No. 62/305,882 with a filing date of Mar. 9, 2016, entitled “Ultra-Safe Enclosure for High Energy Density Devices” which is incorporated in its entirety herein by this reference.

### STATEMENT REGARDING FEDERALLY SPONSORED RESEARCH OR DEVELOPMENT

The invention was made with Government support under Contract Nos. N00014-13-P-1149 and N00014-14-C-0363, both awarded by Office of Naval Research. The Government has certain rights in the invention.

### FIELD

The following disclosure relates generally to a thermal laminate material, more particularly to thermal material comprising at least an intumescent layer and a refractory layer.

### BACKGROUND

Failing high energy density devices create thermal hazards in the form of high heat and fire and explosion hazards. These hazards present a threat to both personnel and surrounding equipment and infrastructure. If possible, these types of devices are located in isolated areas where the threats are minimized. In some cases, isolation is not possible due to confined space requirements. When located in sensitive areas in close proximity with personnel and vital equipment and infrastructure, protection from these threats is necessary.

Complete protection includes mitigation of thermal threats from the devices themselves and from outside sources that could create failure in the devices. Additionally, pressure relief from explosions due to failure is necessary to prevent catastrophic destruction of the enclosure that houses devices. Failing devices are capable of producing very high temperatures in excess of 800° C. Conversely, relatively low temperatures (˜100° C.) can cause failure of these devices. To provide adequate thermal protection, there therefore needs to be protection for the outside from an already failing device and protection for the inside from external thermal sources that could push a device into failure. To protect from explosions due to failing devices, a pressure relief device is necessary. This allows for rapid release of pressure to prevent destruction of the enclosure and damage or injury to surrounding equipment and personnel.

### SUMMARY

These and other needs are addressed by the various embodiments and configurations of the present invention. The present invention can provide a number of advantages depending on the particular configuration.

In accordance with some embodiments is a composition containing an intumescent layer and a refractory layer. The composition is generally a thermal laminate, more generally a thermal laminate material, or even more generally a thermal laminate material that can be in the form of a layer or a thermal laminate layer. The intumescent layer and the refractory layer can be positioned one-on-top of the other. The intumescent layer can include a metallic reinforcement material. In some embodiments, the intumescent layer can include a metallic reinforcement material in the form of mesh. The intumescent layer can be an epoxy-based intumescent material. In some embodiments, the intumescent layer can contain an epoxy resin, an acid catalyst, and at most a trace amount of a solvent. In some embodiments, the intumescent layer can contain an epoxy resin and ammonium phosphate. The refractory material can be a ceramic fiber-based refractory material. In some embodiments, the refractory material can be a ceramic fiber-based refractory material in the form of one of a paper or felt. Moreover, the refractory material can be an alumino-silicate ceramic fiber-based refractory material in the form of one of a paper or felt. In some embodiments, the composition can also contain one or more interfacial materials. In some embodiments, the interfacial material is positioned between the intumescent layer and the refractory layer. In some embodiments, the interfacial material is positioned between the refractory layer and a metallic surface. Stated another way, in some embodiments, one of the following is true for one of the one or more interfacial materials: (i) the interfacial material is positioned between the intumescent layer and the refractory layer; (ii) the interfacial material is positioned between the refractory layer and a metallic surface. The one of the one or more interfacial materials can be one of a layer of air, an adhesive layer, a grease layer, an interfacial metal layer, an interfacial intumescent layer, an interfacial refractory layer, or combination or mixture thereof.

In accordance with some embodiments is a composition containing an intumescent layer comprising an epoxy resin and an acid catalyst and a ceramic fiber-based refractory layer. The composition is generally a thermal laminate, more generally a thermal laminate material, or even more generally a thermal laminate material that can be in the form of a layer or a thermal laminate layer. The intumescent layer and the ceramic fiber-based refractory layer can be positioned one-on-top of the other. The intumescent layer can include a metallic reinforcement material. In some embodiments, the metallic reinforcement material can be in the form of mesh. The intumescent layer can contain at most a trace amount of a solvent. In some embodiments, the acid catalyst can be ammonium phosphate. The ceramic fiber-based refractory material can be in the form of one of a paper or felt. Moreover, the ceramic fiber-based refractory material can be an alumino-silicate. In some embodiments, the composition can also contain one or more interfacial materials. In some embodiments, the interfacial material is positioned between the intumescent layer and the ceramic fiber-based refractory layer. In some embodiments, the interfacial material is positioned between the ceramic fiber-based refractory layer and a metallic surface. Stated another way in some embodiments, one of the following is true for one of the one or more interfacial materials: (i) the interfacial material is positioned between the intumescent layer and the ceramic fiber-based refractory layer; (ii) the interfacial material is positioned between the ceramic fiber-based refractory layer and a metallic surface. The one of the one or more interfacial materials can be one of a layer of air, an adhesive layer, a grease layer, an interfacial metal layer, an interfacial intumescent layer, an interfacial refractory layer, or combination or mixture thereof.

In accordance with some embodiments is a composition having an intumescent layer having a reinforcement material and a ceramic refractory layer. The composition is generally a thermal laminate, more generally a thermal laminate material, or even more generally a thermal laminate material that can be in the form of a layer or a thermal laminate layer. The intumescent layer and the ceramic refractory layer can be positioned one-on-top of the other. The metallic reinforcement material can be in the form of mesh. The intumescent layer can be an epoxy-based intumescent material. In some embodiments, the intumescent layer can contain an epoxy resin, an acid catalyst, and at most a trace amount of a solvent. In some embodiments, the intumescent layer can contain an epoxy resin and ammonium phosphate. The ceramic refractory material can be a fiber-based ceramic refractory material. In some embodiments, the fiber-based ceramic refractory material can be in the form of one of a paper or felt. Moreover, the ceramic refractory material can be an alumino-silicate. In some embodiments, the composition can also contain one or more interfacial materials. In some embodiments, the interfacial material is positioned between the intumescent layer and the ceramic refractory layer. In some embodiments, the interfacial material is positioned between the ceramic refractory layer and a metallic surface. Stated another way in some embodiments, one of the following is true for one of the one or more interfacial materials: (i) the interfacial material is positioned between the intumescent layer and the ceramic refractory layer; (ii) the interfacial material is positioned between the ceramic refractory layer and a metallic surface. The one of the one or more interfacial materials can be one of a layer of air, an adhesive layer, a grease layer, an interfacial metal layer, an interfacial intumescent layer, an interfacial refractory layer, or combination or mixture thereof.

Some embodiments can include a device having a plurality of metallic walls defining a container volume, an intumescent layer having opposing first and second intumescent surfaces, and a non-hinged, non-latched pressure release element. Each wall of the plurality of walls has an interior wall surface and exterior wall surface. Moreover, the first intumescent surface is generally in contact with the interior wall surfaces of the plurality of walls and the second intumescent surface defines the void volume of the container. The intumescent layer can include a metallic reinforcement material. In some embodiments, the intumescent layer can include a metallic reinforcement material in the form of mesh. The intumescent layer can be an epoxy-based intumescent material. In some embodiments, the intumescent layer can contain an epoxy resin, an acid catalyst, and at most a trace amount of a solvent. In some embodiments, the intumescent layer can contain an epoxy resin and ammonium phosphate. Some embodiments, can include one or more interfacial materials. In some embodiments, the interfacial material can be positioned between the intumescent layer and the refractory layer. The one of the one or more interfacial materials can be one of a layer of air, an adhesive layer, a grease layer, an interfacial metal layer, an interfacial intumescent layer, an interfacial refractory layer, or combination or mixture thereof. The pressure relief element can protect the device from high-pressure events by allowing for rapid release of any built-up pressure. The build-up of pressure can protect the device form separation of the walls from the frame. The pressure relief element can be one or more of a pressure relief valve, a burst disc, an explosion vent, or any combination thereof.

Some embodiments can include a device having a plurality of metallic walls defining a container volume, a refractory layer having opposing first and second intumescent surfaces, and a non-hinged, non-latched pressure release element. Each wall of the plurality of walls has an interior wall surface and exterior wall surface. Moreover, the first refractory surface is generally in contact with the interior wall surfaces of the plurality of walls and the second refractory surface defines the void volume of the container. The refractory layer can be a ceramic fiber-based refractory layer. In some embodiments, the refractory layer can be a ceramic fiber-based refractory layer in the form of one of a paper or felt. Moreover, the refractory layer can be an alumino-silicate ceramic fiber-based refractory layer in the form of one of a paper or felt. Some embodiments, can include one or more interfacial materials. In some embodiments, the interfacial material is positioned between the intumescent layer and the refractory layer. In some embodiments, the interfacial material can be positioned between the refractory layer and a metallic surface. The one of the one or more interfacial materials can be one of a layer of air, an adhesive layer, a grease layer, an interfacial metal layer, an interfacial intumescent layer, an interfacial refractory layer, or combination or mixture thereof. The pressure relief element can protect the device from high-pressure events by allowing for rapid release of any built-up pressure. The build-up of pressure can protect the device form separation of the walls from the frame. The pressure relief element can be one or more of a pressure relief valve, a burst disc, an explosion vent, or any combination thereof.

Some embodiments can include a plurality of metallic walls defining a container volume, a thermal laminate material comprising a refractory material and an intumescent material, and a non-hinged, non-latched pressure relief element. Each wall of the plurality of walls has an interior wall surface and exterior wall surface. The refractory material is in contact with the interior wall surfaces of the plurality of walls and wherein the intumescent material defines the void volume of the container. The intumescent material and the refractory material can be positioned one-on-top of the other. The intumescent material can include a metallic reinforcement material. In some embodiments, the intumescent material can include a metallic reinforcement material in the form of mesh. The intumescent material can be an epoxy-based intumescent material. In some embodiments, the intumescent material can contain an epoxy resin, an acid catalyst, and at most a trace amount of a solvent. In some embodiments, the intumescent material can contain an epoxy resin and ammonium phosphate. The refractory material can be a ceramic fiber-based refractory material. In some embodiments, the refractory material can be a ceramic fiber-based refractory material in the form of one of a paper or felt. Moreover, the refractory material can be an alumino-silicate ceramic fiber-based refractory material in the form of one of a paper or felt. In some embodiments, the thermal laminate material can also contain one or more interfacial materials. In some embodiments, the interfacial material is positioned between the intumescent material and the refractory material. In some embodiments, the interfacial material is positioned between the refractory material and the interior wall surface. Stated another way, in some embodiments, one of the following is true for one of the one or more interfacial materials: (i) the interfacial material is positioned between the intumescent material and the refractory material; (ii) the interfacial material is positioned between the refractory material and the interior wall surface. The one of the one or more interfacial materials can be one of a layer of air, an adhesive layer, a grease layer, an interfacial metal layer, an interfacial intumescent layer, an interfacial refractory layer, or combination or mixture thereof. The pressure relief element can protect the device from high-pressure events by allowing for rapid release of any built-up pressure. The build-up of pressure can protect the device form separation of the walls from the frame. The pressure relief element can be one or more of a pressure relief valve, a burst disc, an explosion vent, or any combination thereof.

Some embodiments can include a plurality of metallic walls defining a container volume, a thermal laminate material comprising a refractory material and an intumescent material, and a non-hinged, non-latched pressure relief element. Each wall of the plurality of walls has an interior wall surface and exterior wall surface. The intumescent material is in contact with the interior wall surfaces of the plurality of walls and wherein the refractpru material defines the void volume of the container. The intumescent material and the refractory material can be positioned one-on-top of the other. The intumescent material can include a metallic reinforcement material. In some embodiments, the intumescent material can include a metallic reinforcement material in the form of mesh. The intumescent material can be an epoxy-based intumescent material. In some embodiments, the intumescent material can contain an epoxy resin, an acid catalyst, and at most a trace amount of a solvent. In some embodiments, the intumescent material can contain an epoxy resin and ammonium phosphate. The refractory material can be a ceramic fiber-based refractory material. In some embodiments, the refractory material can be a ceramic fiber-based refractory material in the form of one of a paper or felt. Moreover, the refractory material can be an alumino-silicate ceramic fiber-based refractory material in the form of one of a paper or felt. In some embodiments, the thermal laminate material can also contain one or more interfacial materials. In some embodiments, the interfacial material is positioned between the intumescent material and the refractory material. In some embodiments, the interfacial material is positioned between the intumescent material and the interior wall surface. Stated another way, in some embodiments, one of the following is true for one of the one or more interfacial materials: (i) the interfacial material is positioned between the intumescent material and the refractory material; (ii) the interfacial material is positioned between the intumescent material and the interior wall surface. The one of the one or more interfacial materials can be one of a layer of air, an adhesive layer, a grease layer, an interfacial metal layer, an interfacial intumescent layer, an interfacial refractory layer, or combination or mixture thereof. The pressure relief element can protect the device from high-pressure events by allowing for rapid release of any built-up pressure. The build-up of pressure can protect the device form separation of the walls from the frame. The pressure relief element can be one or more of a pressure relief valve, a burst disc, an explosion vent, or any combination thereof.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples. Further features and advantages will become apparent from the following, more detailed, description of the various embodiments of the invention(s), as illustrated by the drawings referenced below.

FIG. 1 depicts thermal laminate materials according to some embodiments of the present disclosure.

FIG. 2 depicts a form according to some embodiments of the present disclosure.

FIGS. 3A-3F depict some performance features according to some embodiments of the present disclosure.

FIG. 4 depicts some temperature performance features according to some embodiments of the present disclosure.

FIG. 5 depicts some temperature performance features according to some embodiments of the present disclosure.

FIG. 6 depicts some temperature performance features according to some embodiments of the present disclosure.

FIG. 7 depicts some temperature performance features according to some embodiments of the present disclosure.

FIG. 8 depicts some temperature performance features according to some embodiments of the present disclosure.

FIG. 9 depicts some embodiment of the present disclosure.

### DETAILED DESCRIPTION

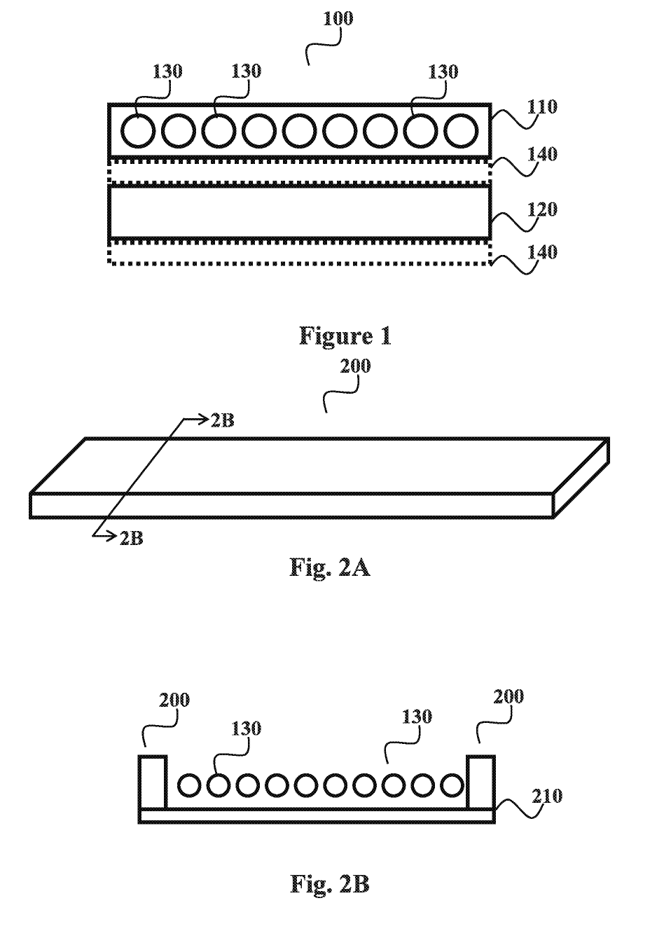

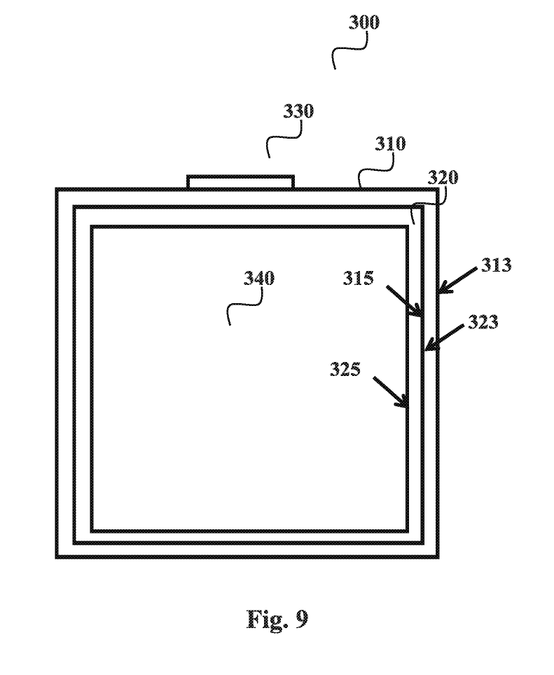

These and other needs are addressed by the present disclosure. In accordance with some embodiments is a thermal laminate material 100 (see FIG. 1). comprising a refractory material 120 and an intumescent material 110. The refractory 120 and intumescent 110 materials are generally stacked one-on-top of the other. The thermal laminate material 100 typically includes a stacking of the refractory layer 120 and the intumescent layer 110 containing a reinforcement material 130 one-on-top of another. The refractory 120 and intumescent 110 materials are commonly in the form of layers. More commonly, the refractory layer 120 and intumescent layer 110 are stacked one-on-top of the other. Typically, the refractory material (or layer) 120 is positioned adjacent to a metallic surface 325 (FIG. 9), such as a metallic surface 325 of a metallic container 300. The metallic surface 315 of the metallic container 300 generally provides structural support and an external, protective layer. In some embodiments, the thermal laminate layer 100 can be used as formed. In some embodiments, the thermal laminate layer 100 can be cut to one or more of any desired size and shape. Some embodiments can include creating one or more voids, channels, apertures, or combination thereof in thermal laminate (not depicted). The one or more of voids, channels, apertures, or combination thereof typically can be utilized for securing the thermal laminate 100 to a surface (such as, but not limited to metallic surface 315). In some embodiments, the apertures and/or voids can be configured to accept a blot. Generally, no adhesive or other binding mechanism or composition is utilized to bond the refractory layer 120 and the intumescent layer 110 containing the reinforcement material 130 together. The refractory layer 120 and intumescent 110 layer are typically not bonded together by an adhesive or other binding composition (not depicted) to provide an additional thermal insulation, such as a thermal insulative layer of air 140.

The thermal laminate 100 can generally be positioned adjacent to a metallic surface 315. The thermal laminate 100 can be retained adjacent to the metallic surface 315 by any method known to those of ordinary skill in the art. Some non-limiting examples of retaining the thermal laminate material 100 adjacent to a metallic surface 315 are securing the thermal laminate material 100 to the metallic surface 315 using fasteners (not depicted) interconnected to the one or more of voids, channels, apertures, or combination thereof (not depicted) contained in the thermal laminate material layer 100. It can be appreciated that the refractory layer 120 is generally positioned nearer the metallic surface 315 than the intumescent layer 110. However, in some embodiments, the intumescent layer 110 can be positioned nearer the metallic layer 315 than the refractory layer 120. Generally, there is no adhesive or other attachment mechanism to bond the intumescent 110 and refractory 120 layers because it was found that generally no interfacial material provided significant additional thermal insulation. An electromagnetic interference gasket material (not depicted) can be used to seal the seams of the metallic enclosure (or container) 300. The electromagnetic interference gasket material can be installed by affixing an adhesive surface to the intumescent layer 100 such that the electromagnetic interface gasket would interface with the frame to create a seal.

When exposed to thermal energy, the intumescent layer 110 can expand to produce a char layer. The char layer can have insulative properties. That is, the char layer can be a thermal insulator. Moreover, the char layer thickness can vary depending on one or more of the degree, extent, and period of thermal energy exposure. Generally, the char layer thickness increases with greater levels of thermal energy applied. Also, the char layer thickness usually increases with longer periods of time of exposure to the applied thermal energy. The char layer can thermally insulate the outside of the metallic container from an internal thermal threat.

The refractory material 120 can be any material that maintains its strength at high temperatures. The refractory material 120 is usually a thermal insulator material. The thermal insulator can act as a thermal insulation shield. The thermal insulator material can protect any internal contents of the metallic container from external thermal threats.

High temperature for a refractory material 120 generally refers to a temperature of one of no more than about 3,500 degrees Celsius, more generally no more than about 3,000 degrees Celsius, even more generally no more than about 2,500 degrees Celsius, yet even more generally no more than about 2,000 degrees Celsius, still yet even more generally no more than about 1,500 degrees Celsius, or yet still even more generally no more than about 1,000 degrees Celsius, and typically one of more than about 1,000 degrees Celsius, even more typically more than about 900 degrees Celsius, yet even ore typically more than about 500 degrees Celsius, still yet even more than about 200 degrees Celsius, still yet even more than about 100 degrees Celsius, or yet still more than about 60 degrees Celsius. In some embodiments, the refractory material 120 can be a ceramic fiber-based refractory material. In general, the ceramic fiber-based refractory material is a lightweight insulating material having one of more of a low thermal mass (which means that it does not retain heat), a low thermal conductivity and a high thermal shock resistance. The ceramic fiber-based refractory material can be an extremely effective insulation material. The ceramic fiber-based refractory material is typically suitable for applications where traditional refractory materials cannot be used. Typically, the ceramic fiber-based refractory material can comprise high purity alumino-silicate materials. Ceramic fibers are generally produced by melting high purity alumino-silicate materials in an electric arc furnace. A melt stream is poured for the electric arc furnace and cooled to form the fiber strands from which the ceramic fiber-based refractory material is produced. The ceramic fiber-based refractory material is generally substantially free of asbestos. The fiber strands can be combined with one or more binding materials to form a ceramic fiber-based paper or felt. These ceramic fiber-based papers or felts commonly melt at about 1,800 degrees Celsius. Moreover, these ceramic fiber-based paper or felts are generally suitable as thermal insulators up to temperatures of about 1,260 degrees Celsius, more generally up to about 1, 300 degrees Celsius. The fiber-based refractory material can be in the form of board, blanket, coating, tile, brick, textile, paper, felt or combination thereof. In some embodiments, the ceramic fiber-based refractory material can comprise a refractory paper, felt, or combination thereof. In some embodiments, the ceramic fiber-based refractory material can provide superior thermal insulation by restricting heat transfer. In some embodiments, the fiber-based refractory material can comprise FIBERFRAX™ 970J paper.

The refractory material 120 is used as provided. The as provided refractory material 120 is typically cut to the shape and size of the desired refractory layer 120. When the desired size of the refractory layer 120 is greater than the as provided size, the as provided refractory material 120 is cut into a plurality of shapes and sizes that can be combined to form the desired shape and size of the refractory layer 120. The plurality of shapes and sizes of refractory material 120 are usually oversized to slightly overlap and, therefore, prevent any gaps within the refractory layer 120.

The intumescent material 110 can be any material that, when exposed to thermal energy, undergoes a chemical reaction that results in one or more of expansion and charring of the intumescent material 110 which can generally result in a heat insulating char. Typically, the intumescent material 110 when exposed to thermal energy swells and chars. The swelled char, compared to unchared intumescent material 110, generally has an increased volume. The increase in volume typically decreases the density of the intumescent material 110. The heat insulating char can be a hard insulating or a soft insulating char. The heat insulating char can be a high or low expansion char. It can be appreciated that, a hard insulating char can be a high or low expansion, hard-insulating char. Similarly, a soft insulating char can be a high or low expansion, low insulating char. Moreover, the low expansion, low insulating char can be one of a water-base, solvent-based, or epoxy-based intumescent material 110. While not wanting to be limited by example, soft char intumescent materials produce a char that is a poor conductor of heat. The soft char can retard heat transfer. The char can be dense and robust (hard char) or light with lots of air (soft char). Low expansion char generally produces a thin char layer, while high expansion char commonly produces a char layer thicker than the base intumescent material thickness.

In some embodiments, the char can comprise a microporous carbonaceous foam. The microporous carbonaceous foam is generally formed by a chemical reaction of components comprising the intumescent material 110: ammonium polyphosphate, pentaerythritol, and melamine. This reaction takes place in a matrix formed by the molten binder. The molten binder typically comprises one or more of vinyl acetate copolymer, styrene acrylate, a combination thereof, and a mixture thereof. In some embodiments, the intumescent material 110 can contain hydrates. The hydrate containing coatings, when subjected to thermal energy, can release water vapor. The water vapor can be released one or more of prior to, during, or prior to and during the char formation. In some embodiments, hard chars are produced with compositions containing one or more of sodium silicates and graphite. Typically, hard chars are generally unsuitable for interior fireproofing.

In some embodiments, the intumescent material 110 can be an epoxy-based intumescent material 110. In some embodiments, intumescent material 110 can be CARBOLINE THERMOLAG™ 3000 SA. In some embodiments, the intumescent material 110 can comprise a 100% solids epoxy based intumescent material 110 designed to fireproof steelwork for up to a four-hour fire rating. A 100% solids coating generally refers to a liquid material that will change from a liquid to a solid without a substantial loss in mass. Typically, a 100% solids coating contains either no solvent or a trace amount of solvent from the manufacturing process. An epoxy intumescent material 110 usually comprises an organic binder resin, such as an epoxy, and an acid catalyst, such as without limitation ammonium polyphosphate. The ammonium polyphosphate decomposes when subjected to thermal energy to yield a mineral acid. The mineral acid produced, can react with a carbonific source, for example, pentaerythritol, to produce a carbon char. The intumescent material 110 can include a spumific (foam-producing) agent, such as without limitation a melamine. The spumific agent can react with the acid source and decompose. This decomposition product can generate an inert gas that expands the char. It can be appreciated that, although more complex processes can also occur beyond these basic reactions. For example, filler particles can be incorporated into the intumescent material 110 to act as nucleating sites or “bubble growth” sites. It can also be appreciated that the organic binder resin, such as the epoxy, can affect one or more of the softening and charring of the intumescent material 110. Furthermore, different resins can be used in the formulation of an intumescent material 110. For example, water-based acrylic resins can be used in formulating intumescent materials 110 utilized in dry, internal locations; solvent-based acrylic resins are generally used when formulating intumescent materials 110 utilized in internal or sheltered external locations; and one or both of solvent-based and solvent-free epoxy resins can be used when formulating intumescent materials 110 utilized for substantially any location or condition.

The intumescent layer 110 can commonly have a thickness from one of more than about 0.2 cm; more commonly more than about 0.3 cm, even more commonly more than about 0.4 cm, yet even more commonly more than about 0.5 cm, still yet even more commonly more than about 0.6 cm, still yet even more commonly more than about 0.7 cm, still yet even more commonly more than about 0.8 cm, still yet even more commonly more than about 0.9 cm, still yet even more commonly more than about 1.0 cm, still yet even more commonly more than about 1.1 cm, still yet even more commonly more than about 1.25 cm, still yet even more commonly more than about 1.5 cm, still yet even more commonly more than about 1.75 cm, still yet even more commonly more than about 2.0 cm, still yet even more commonly more than about 2.25 cm, still yet even more commonly more than about 2.5 cm, or yet still even more commonly more than about 2.75 cm, and one of typically no more than about 1.00 cm, more typically no more than about 1.25 cm, even more typically no more than about 1.5 cm, yet even more typically no more than about 1.75 cm, still yet even more typically no more than about 2.0 cm, still yet even more typically no more than about 2.25 cm, still yet even more typically no more than about 2.5 cm, still yet even more typically no more than about 2.75 cm, still yet even more typically no more than about 3.0 cm, still yet even more typically no more than about 3.25 cm, still yet even more typically no more than about 3.5 cm, still yet even more typically no more than about 3.25 cm, still yet even more typically no more than about 3.5 cm, still yet even more typically no more than about 3.75 cm, still yet even more typically no more than about 4.0 cm, still yet even more typically no more than about 4.5 cm, or yet still even more typically no more than about 5.0 cm.

The refractory layer 120 can usually have a thickness of more than about 0.2 cm, more usually of more than about 0.4 cm, even more usually of more than about 0.6 cm, yet even more usually of more than about 0.7 cm, still yet even more usually of more than about 0.8 cm, still yet even more usually of more than about 0.9 cm, still yet even more usually of more than about 1.0 cm, still yet even more usually of more than about 1.1 cm, still yet even more usually of more than about 1.2 cm, still yet even more usually of more than about 1.3 cm, still yet even more usually of more than about 1.4 cm, still yet even more usually of more than about 1.5 cm, still yet even more usually of more than about 1.6 cm, still yet even more usually of more than about 1.7 cm, still yet even more usually of more than about 1.8 cm, still yet even more usually of more than about 1.9 cm, still yet even more usually of more than about 2.0 cm, or yet still even more usually of more than about 2.1 cm. The refractory layer can commonly have a thickness of no more than about 2.5 cm, more commonly of no more than about 2.4 cm, even more commonly of no more than about 2.3 cm, yet even more commonly of no more than about 2.2 cm, still yet even more commonly of no more than about 2.1 cm, still yet even more commonly of no more than about 2.0 cm, still yet even more commonly of no more than about 1.9 cm, still yet even more commonly of no more than about 1.8 cm, still yet even more commonly of no more than about 1.7 cm, still yet even more commonly of no more than about 1.6 cm, still yet even more commonly of no more than about 1.5 cm, still yet even more commonly of no more than about 1.4 cm, still yet even more commonly of no more than about 1.3 cm, still yet even more commonly of no more than about 1.2 cm, still yet even more commonly of more than about 1.1 cm, still yet even more commonly of no more than about 1.0 cm, still yet even more commonly of no more than about 0.9 cm, still yet even more commonly of no more than about 0.8 cm, still yet even more commonly of no more than about 0.7 cm, still yet even more commonly of no more than about 0.6 cm, still yet even more commonly of no more than about 0.5 cm, still yet even more commonly of no more than about 0.4 cm, still yet even more commonly of no more than about 0.3 cm, or yet still even more commonly of no more than about 0.2 cm.

In some embodiments, the metallic container 300 can comprise any structural metallic material. The structural metallic material can be without limitation mild steel, 304 stainless steel, 316 stainless steel, aluminum, and so forth. The metallic container 300 can comprise metallic walls of any thickness.

In accordance with some embodiments, the thermal laminate material 100 can comprise one or more of a reinforcement material 130 and one or more interfacial materials 140. In some embodiments, the thermal laminate material 100 can contain a reinforcement material 130. In some embodiments, the thermal laminate material 100 can contain one or more interfacial materials 140.

The reinforcement material 130 can be positioned in the intumescent layer 110. The reinforcement material 130 can provide one or more of support and reinforcement of the intumescent layer 120. The reinforcement material 130 can generally have structural rigidity and can support the intumescent layer 110. While not wanting to be limited by example, the reinforcement material 130 can provide shape to the intumescent layer 110. Moreover, an intumescent layer 110 having a reinforcement material 130 can generally retain its shape and structure better than an intumescent layer 110 lacking a reinforcement material 130. In some embodiments, the reinforcement material 130 can prevent the propagation of cracks through the intumescent layer 110, such as when the intumescent material 110 chars. The reinforcement material 130 can be any suitable material. Non-limiting examples of suitable reinforcement materials 130 are metal mesh, expanded metal, sheet metal, copper mesh, and so forth. Selection of the reinforcement material 130 can be influenced by weight requirements, needed support, and additional requirements (such as electromagnetic interferences).

In accordance with some embodiments, the reinforcement material 130 can comprise a mesh material. More particularly, the reinforcement material 130 can comprise a metallic mesh material. The mesh can be provided in a flattened form, substantially free of and bumps and waves. It can be appreciated that if the provided reinforcement material 130 is in an un-flattened form, it can be flattened before use. Similarly, if the reinforcement material 130 is provided with one or more of bumps and waves, the one or more of bumps and waves can be substantially removed (such as flattened or smoothed out) before use. Some embodiments can include a step of hot rolling the reinforcement material 130 to one or more of flatten and remove bumps and/or waves from the reinforcement material 130. The reinforcement material 130 can be provided in any size and configuration. For example, the reinforcement material 130 can be provided in the form of a sheet or roll. The reinforcement material 130 can be provided with any size of orifices and/or voids, such as without limitation from about 0.6 to about 1.3 cm orifices and/or voids. In some embodiments, the reinforcement material 130 has orifices of an average and/or mean size of about 0.64 cm. In some embodiments, the reinforcement material 130 has orifices of an average and/or mean size of about 1.27 cm.

In some embodiments, the reinforcement material 130 can be mounted in a frame 200 (FIGS. 2A and 2B). The frame 200 can comprise any suitable material, such as without limitation a metallic and/or wooden material. The frame can help to flatten the reinforcement material 130. The frame 200 can also help prevent curling of the reinforcement material 130. In some embodiments, a release film 210 is mounted on one side of the frame 200. The release film 210 is pulled taunt when mounted to the frame 200 to form a substantially smooth surface. In some embodiments, the release sheet 210 and frame 200 can generally comprise materials that do not adhere to the intumescent material 110. In some embodiments, the frame 200 can usually be treated or modified to not substantially adhere to the intumescent material 110.

In some embodiments, the reinforcement material 130 can be in the form of metallic sheet or metallic mesh. It can be appreciated, that when the reinforcement material 130 is in the form of a metallic mesh it can one or more of decrease the weight of the thermal laminate material 100, decrease the thermal laminate 100 thickness, and generally simplify the thermal laminate material 100 manufacturing process (such as, but not limited to casting of the intumescent layer 110 and/or cutting of the intumescent layer 110).

The one or more interfacial materials 140 can provide insulative properties. In some embodiments, the one or more interfacial materials 140 can comprise commonly one of one interfacial layer 140, more commonly two interfacial layers 140, even more commonly three interfacial layers 140, or yet even more commonly four interfacial layers 104. In some embodiments, the interfacial material 140 can be positioned between the intumescent 110 and refractory 120 layers. In some embodiments, the interfacial material 140 can be positioned between the refractory layer 120 and a metallic surface 315. In some embodiments having two interfacial materials 140, a first interfacial material 140 is positioned between the intumescent 110 and refractory 120 layers and a second interfacial material 140 is positioned between the refractory layer 120 and the metallic surface 315. In accordance with some embodiments, the one or more interfacial materials 140 can comprise one or more of an air interface, an adhesive layer, a grease layer, an interfacial metal layer, an interfacial intumescent layer, an interfacial refractory layer, or any combination or mixture thereof.

In some embodiments, the intumescent material 110 can be prepared according to the recommendations of the manufacturer. In some embodiments, the intumescent material 110 can be prepared with any suitable solvent to reduce one or more of the viscosity and surface tension of the intumescent material 110 for one or more of pouring and spreading of it in the mold. After preparing the intumescent material 110, with or without a suitable solvent, the intumescent material 110 is poured into the frame 200 and spread to substantially uniform thickness. The intumescent layer 110 thickness is generally sufficient to cover and contained substantially most, if not all, of the reinforcement material 130 within the intumescent layer 110. Moreover, the intumescent layer 110 thickness is also sufficient to provide the necessary fire rating protection, in minutes of protection. The fire rating protection, in minutes, is commonly one of about 15 minutes, more commonly about 20 minutes, even more commonly about 30 minutes, yet even more commonly about 45 minutes, still yet even more commonly about 60 minutes, still yet even more commonly about 80 minutes, still yet even more commonly about 90 minutes, or yet still even more commonly about 120 minutes. After spreading the intumescent layer 110 substantially evenly within the frame 200, the intumescent layer 110 is typically cured per the manufacture's recommendations before removing the intumescent layer 110 from the frame. The cure time can be one of generally about 0.25 days, more generally about 0.5 days, even more generally about 0.75 days, yet even more generally about 1 day, still yet even more generally 1.5 days, still yet even more generally 2 days, still yet even more generally 3 days, still yet even more generally 4 days, still yet even more generally 5 days, still yet even more generally 6 days, or yet still even more generally 7 days. After removal from the frame, the cured intumescent layer 110 containing the reinforcement material 130 can be used as is or cut to any one or more of shape and size. It can be appreciated that a vacuum step, after the spreading step and before the cure step, can be included to remove any bubbles contained in the as poured intumescent layer 110.

Some embodiments can include an explosion relief element 330. The explosion relief element 330 can be a pressure relief device. The pressure relief element 330 generally protects the metallic container 300 from high-pressure events by allowing for rapid release of any built-up pressure. Any build-up of pressure can damage the metallic container 300 such as without limitation separation of the walls from the frame. The pressure relief element 330 can be in the form of a pressure relief valve, a burst disc, an explosion vent, or any combination thereof. The pressure relief device generally provides protection from one or more of thermal and over-pressure threats.

These components cover the configuration of the laminate structure that provides thermal protection. They can be used all together, or in part, such as using only a metal wall and intumescent layer or only a metal wall and refractory material.

### EXAMPLES

### Preliminary Small Sample Testing:

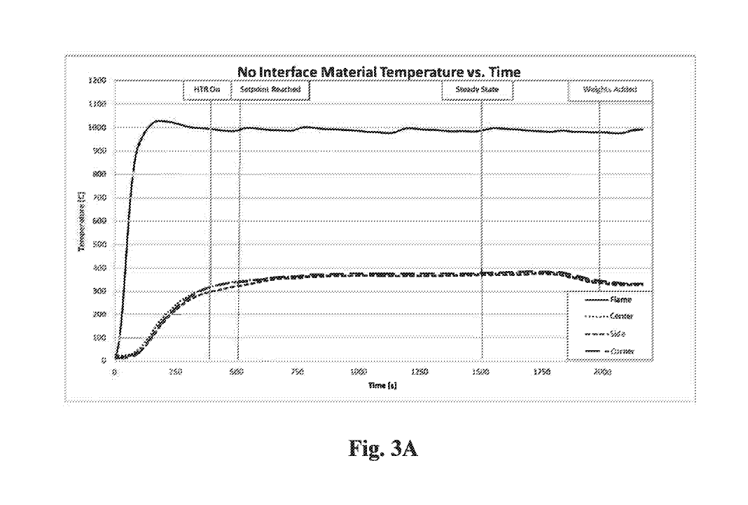

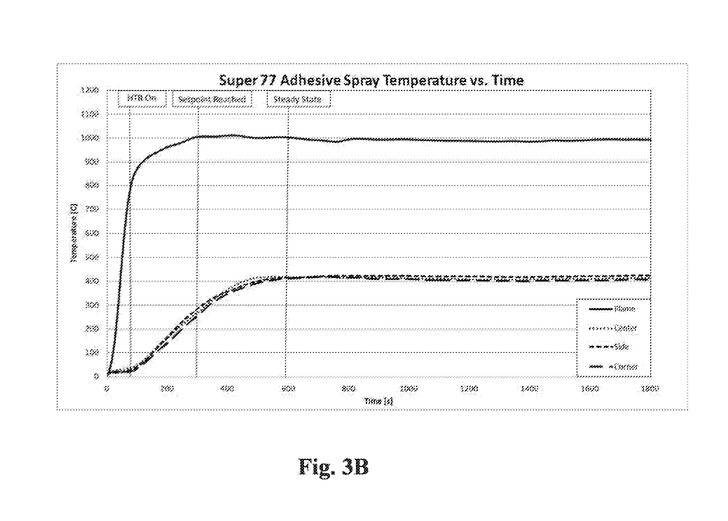

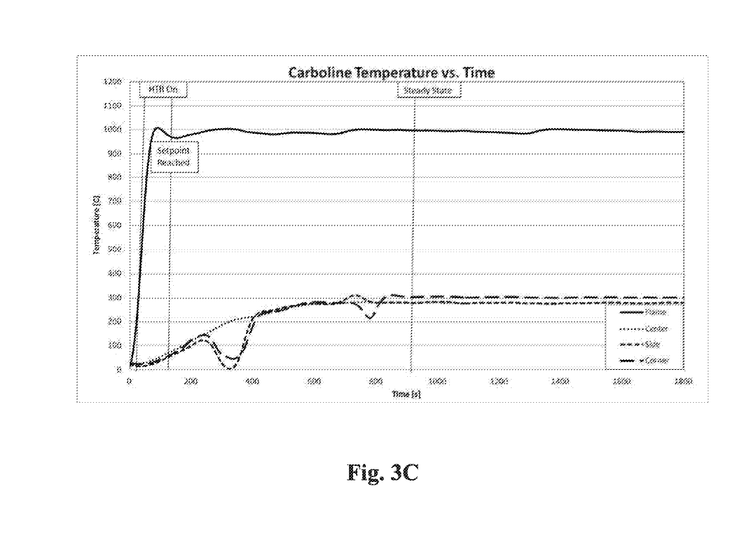

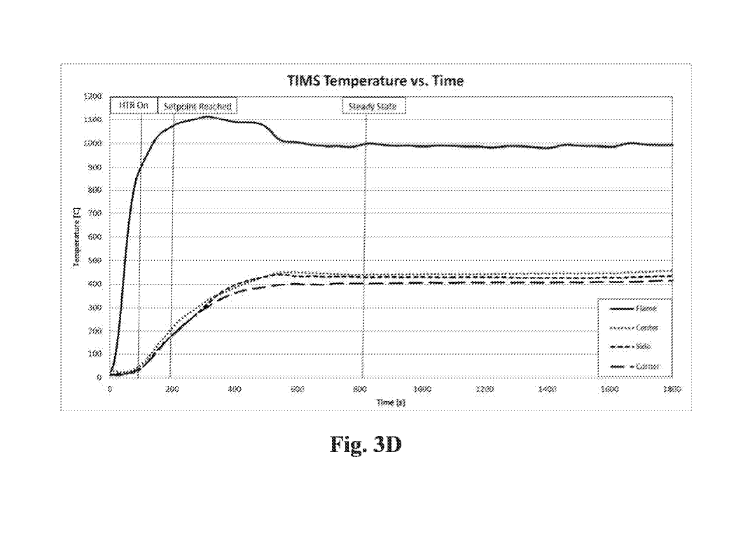

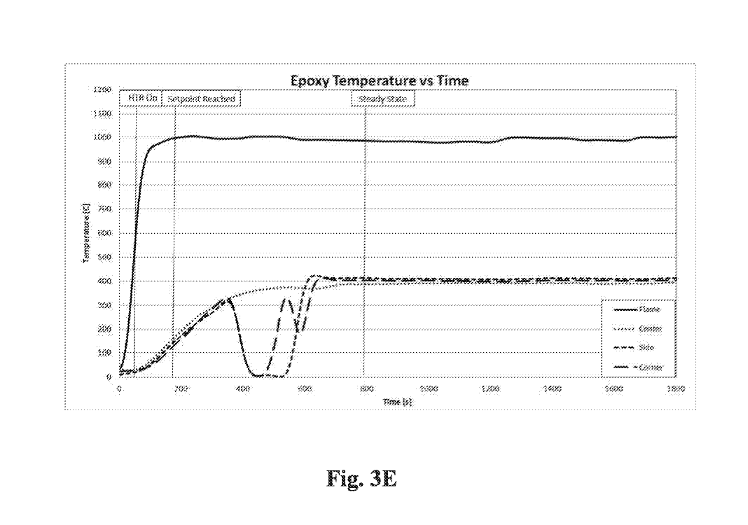

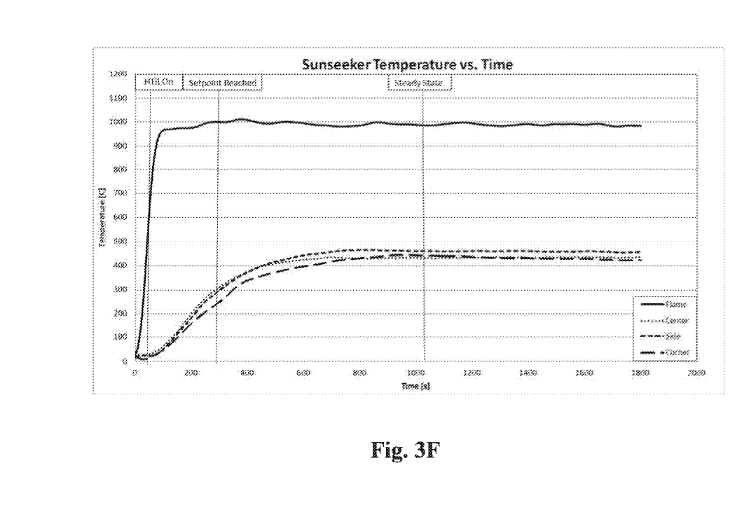

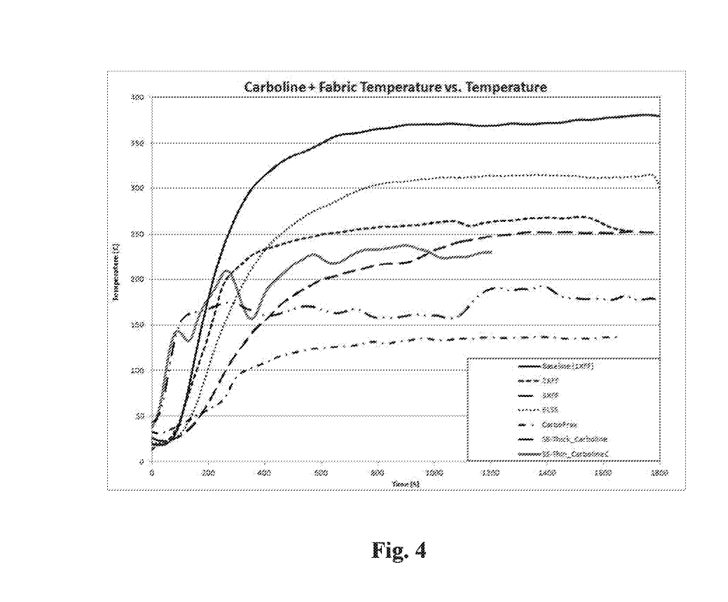

The standard setup for small scale flame testing, using a Meker burner, consisted of a 13-inch squared piece of insulation board with a 5.25 inch squared hole that was used as a platform for the samples. Each thermal laminate sample (approximately 6-inch squared) was centered over the hole on the platform during testing. A commercial propane tank fueled the Meker burner, and small adjustments were made to the tank valve to maintain a flame temperature of about 1,000 degrees Celsius. Three thermocouples were placed at about the same positions for all samples: one in the center, one 2.75 inches towards the side, and one 4 inches towards the corner of the 6-inch squared thermal laminate sample. The entire sample heated up fairly evenly without much change in the x- or y-directions, causing all three thermocouples to read similar temperatures. Various embodiments of the thermal laminate material were thermally tested (see FIGS. 3A-3F and FIG. 4). Some embodiments included a CARBOLINE™ intumescent material (Thermo-Lag 3000A) for the interfacial bonding. The intumescent materials (such as, the Carboline intumescent material) are generally designed to face a flame from an industrial fire, as such they are typically applied as a paint or coating to solid surfaces. When contacted by flame or high heat, the intumescent material expands. The expanded intumescent material can act as an insulating ash layer that is several times thicker than the original layer.

FIG. 4 depicts the temperature properties of various embodiments of the thermal laminate layer having different refractory layers (as for example, Fiberfrax and Sunseeker) and different thickness of the intumescent layer. Four of the samples implement a single variation to the baseline configuration. First, the effect of the different refractory layer thicknesses (such as Fiberfax) in the thermal laminate material was investigated by comparing a single sheet of the refractory layer (1XFF) to two otherwise identical thermal laminate layers that use two sheets of refractory (2XFF) and three sheets of refractory (3XFF), respectively of the Fiberfax refractory layer. A drop in the steady state temperature of about 25 degrees Celsius was observed from the 1XFF to the 2XFF samples, but in the 2XFF to the 3XFF samples a drop in the steady state temperature was less than 25 degrees Celsius. Hence, it is believed that the refractory layer (such as, Fiberfrax) produces a large but decreasing improvement in the insulation effectiveness as it becomes thicker in the thermal laminate material. Thermal laminate layers having different refractory layers were compared, such as a Sunseeker refractory layer (BLSS) and a Fiberfrax refractory layer (1XXF, 2XXf, and 3XXF). The Sunseeker refractory layer had a thickness of about three sheets of Fiberfrax, yet it performed poorer than the 2XFF Fiberfrax sample. Various intumescent layer thicknesses were also thermally tested. For these thermal tests, the intumescent material was applied directly to a steel plate. By applying the intumescent layer directly to the steel plated, the effect of the refractory layer was eliminated and only the thickness of the intumescent layer need be considered. The thicker intumescent layer (SS-Thick_Carboline) had about from 50 to about 75 degree Celsius reduction in topside temperature than did the thinner intumescent layer (SS-Thin_Carboline). The effect of the direction of applying the thermal energy to the thermal laminate material (comprising an intumescent layer and a refractory layer) was also evaluated. In this test a layer of intumescent material is applied to the flame-facing side made of metallic (aluminum) material (labeled, CarboFrax). The direction of applying thermal energy did not substantially affect the insulative properties of the thermal laminate material, the steady state temperature remains below 150 degrees Celsius, even after the entire back side was engulfed in a 1000 degrees Celsius flame for over 30 minutes. It can be appreciated that the thermal laminate material structure provides substantial thermal performance at low weight and thickness.

Various embodiments of thermal laminate material can include without limitation: an intumescent layer (such as, Carboline applied to a thin steel plate) and a refractory layer (such as, Fiberfrax); an intumescent layer (such as, Carboline) containing a metallic reinforcement (such as a metallic mesh) and a refractory layer (such as, Fiberfrax); and an intumescent layer (such as, Carboline) and a refractory layer (such as, Fiberfrax).

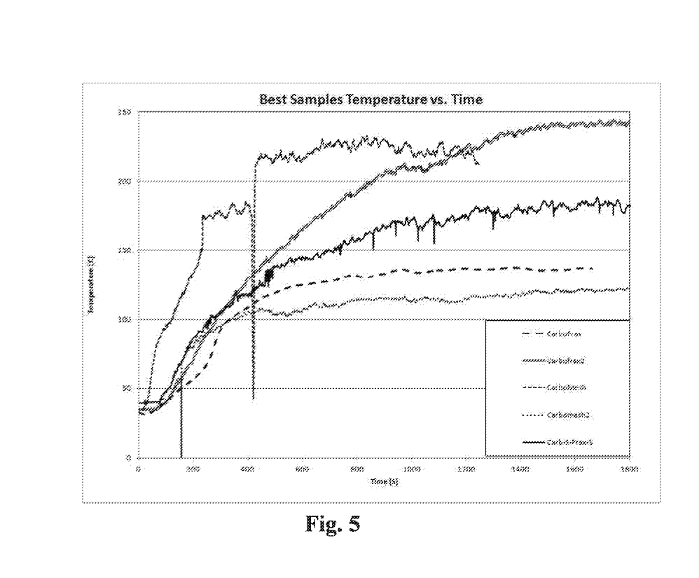

As seen in FIG. 5, the thermal laminate material can provide insulation to the cool side of the thermal laminate material. The thermal laminate materials denoted CarboFrax and CarboMesh maintained steady state temperatures below about 150 degrees Celsius even after the entire back side was engulfed in flame having a temperature of about 1,000 degree Celsius for over 30 minutes. The other thermal laminate materials maintained a steady state temperature of less than about 250 degrees Celsius. It is believed that some of the variation in performance of the various embodiments could be due to some differences in one or more of intumescent material loading and curing, which can result in ash layer thickness when the intumescent layer is exposed to a flame.

### Internal Fire Exposure Testing

Initially, the internal fire exposure testing was performed on a wall of an enclosure that had been removed from the frame. The edges of the wall were insulated using Fiberfrax Duraboard and insulation to minimize heat loss around the edges of the wall and to focus the heat transfer straight through the thermal laminate material. The burner was positioned 3 inches away from the intumescent material layer surface. The flame was regulated to have temperature of about 1,000 degrees Celsius. The temperature of the external wall surface was monitored using a combination of thermocouples and a FLIR thermal camera. The thermal emissivity of stainless steel was too low for the thermal camera to provide accurate readings, so Kapton tape squares were used as targets.

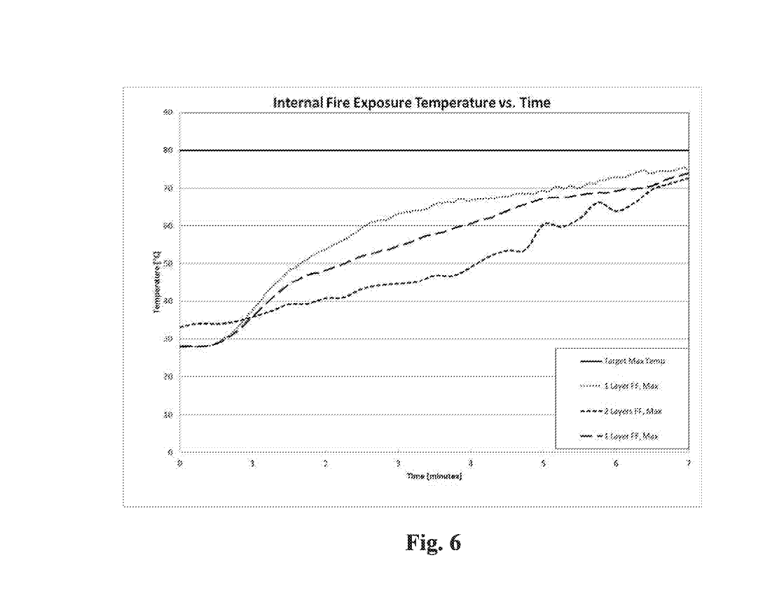

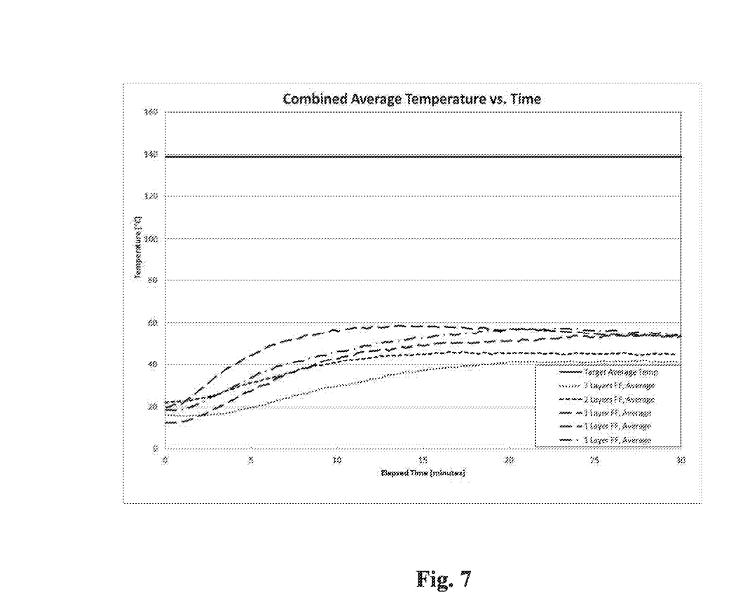

Further internal fire exposure testing was conducted with the objective that, under an internal fire load, the external wall should not exceed 80 degrees Celsius after seven minutes of flame exposure of about 1000 degrees Celsius. The 80 degree Celsius temperature target was chosen because it represents the temperature at which human skin will start to burn if in contact for more than about one second. The set of tests performed was designed to help determine the appropriate number of refractory layers (such as in this test, Fiberfrax) in the thermal laminate material that will provide adequate thermal protection. Two tests were performed with a thermal laminate material having one refractory layer and one test was performed with a thermal laminate material having two refractory layers. Previous testing identified the hottest parts of the wall to be the upper and middle center. The temperature was therefore measured at these locations as the most likely location of the maximum temperature (see FIG. 6). Each thermal laminate material wall configuration successfully kept the external temperature below about 80 degrees Celsius over the seven-minute testing period. The test with thermal laminate material having two refractory layers of kept the temperature lower than the thermal laminate material having one refractory layer tests, during the middle portion of the test; however, at the end of each of the tests the external wall temperatures were substantially about the same. Moreover, during the flame exposure, the intumescent layer (such as in this test, Carboline) expanded to form an insulating char layer having a thickness from about 2 to about 3 inches. The char layers act as a further thermal barrier that slows the transfer of heat through the thermal laminate material to the external wall.

### External Fire Exposure Testing

A representative, small-scale Navy external fire testing protocol that provides guidance regarding a material's potential to pass an external fire exposure testing conducted according to the US Navy N-30 fire rating requirements was utilized. The Navy N-30 fire rating test is part of several MIL-SPEC documents, for example MIL-STD-3020, MIL-PRF-32161 and MIL-DTL-2036E, each of which is incorporated herein its entirety by this reference. The N-30 testing requirements are substantially similar to and based on fire resistance standard, UL 1709, the entire contents of which is incorporated herein by this reference. The Navy testing protocol includes 30 minutes of exposure at 1093 degree Celsius and 65,000 BTU/ft²/hr heat flux which is particularly difficult to implement and can only be performed by a few accredited specialized laboratories, at significant cost. Therefore, the small-scale external fire testing protocol was undertaken. The test setup utilizes a single wall panel insulated on the edges. A new high-output propane burner capable of delivering the required heat output of approximately 65,000 BTU/hr was positioned 18 inches from the wall surface. The heat output was monitored, the propane tank was placed on a scale and the fuel consumption was tracked over time. The temperature of the internal surface was recorded with the FLIR thermal camera.

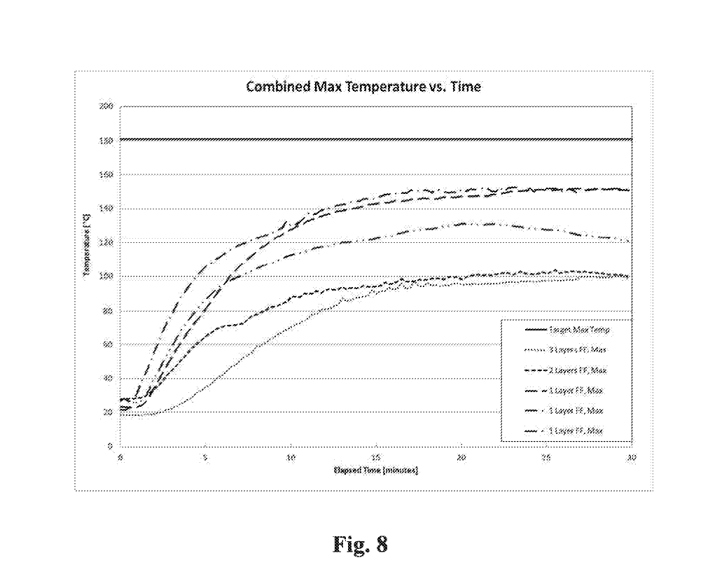

Laminate configurations with different numbers of Fiberfrax layers were tested to determine how many layers provide sufficient thermal performance against the test standard. The N-30 fire rating for (Type I) panels dictates that under thermal exposure (such as, fire or flame) conditions that the average temperature of the panel should be no more than 139 degrees Celsius above the ambient temperature while the maximum temperature should not be more than about 181 degrees Celsius over the ambient temperature. The small-scale Navy test utilized eight thermocouples. In this test setup, a thermal camera was used to monitor the temperature of the entire panel and identify the absolute maximum and average. The average and maximum temperatures are determined from these eight thermocouples (see FIGS. 7 and 8).

All thermal laminate material configurations subjected to the small-scale N-30 testing passed. Three repeats of the thermal laminate material having a single refractory layer (such as Fiberfrax) show that a single refractory layer can provide sufficient thermal protection. That is, a thermal laminate material having a single refractory layer had a maximum temperature limit of about 150 degrees Celsius in the small-scale N-30 test. Furthermore, a thermal laminate material having two refractory layers (such as Fiberfrax) can provide sufficient thermal protection. The thermal laminate material having two refractory layers had a maximum temperature limit of about 100 degrees Celsius in the small-scale N-30 test. Moreover, the condition of the steel wall and intumescent layer (such as Carboline) were good at end of the test. The steel did reveal some slight charring but did not seem to be affected structurally. The intumescent material layer showed very little evidence of heat exposure. In some of the thermal laminate material having a single refractory layer tests, very small bubbles formed in the intumescent material layer. The bubbles were not noticeable unless viewed up close.

It should be noted that it is difficult to maintain a constant heat flux using a high-output propane burner. Over the course of a test, the heat output seemed to fluctuate slightly without adjusting the burner settings. This made it difficult to target an exact and constant heat output, but the fluctuations did not appear to be substantial and qualitative monitoring of the flame helped keep tests consistent to each other.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A composition, comprising:
an intumescent layer; and
a refractory layer, wherein the intumescent layer and the refractory layer are positioned one-on-top of the other.

2. The composition of claim 1, wherein the intumescent layer includes a metallic reinforcement material.

3. The composition of claim 1, wherein the intumescent layer includes a metallic reinforcement material in the form of mesh.

4. The composition of claim 1, further comprising:
one or more interfacial materials, wherein one of the following is true for one of the one or more interfacial materials:
(i) the interfacial material is positioned between the intumescent layer and the refractory layer; and
(ii) the interfacial material is positioned between the refractory layer and a metallic surface, and
wherein the one of the one or more interfacial materials comprises one of a layer of air, an adhesive layer, a grease layer, an interfacial metal layer, an interfacial intumescent layer, an interfacial refractory layer, or combination or mixture thereof.

5. The composition of claim 1, wherein the refractory material comprises a ceramic fiber-based refractory material.

6. The composition of claim 1, wherein the refractory material comprises a ceramic fiber-based refractory material in the form of one of a paper or a felt.

7. The composition of claim 1, wherein the refractory material comprises an alumino-silicate ceramic fiber-based refractory material in the form of one of a paper or a felt.

8. The composition of claim 1, wherein the intumescent layer comprises an epoxy-based intumescent material.

9. The composition of claim 1, wherein the intumescent layer comprises an epoxy resin, an acid catalyst, and at most a trace amount of a solvent.

10. The composition of claim 1, wherein the intumescent layer comprises an epoxy resin and ammonium phosphate.

11. A composition, comprising:
an intumescent layer comprising an epoxy resin and an acid catalyst; and
a ceramic fiber-based refractory layer, wherein the intumescent layer and ceramic fiber-based refractory layer are positioned one-on-top of the other.

12. The composition of claim 11, wherein the intumescent layer includes a metallic reinforcement material.

13. The composition of claim 11, wherein the ceramic fiber-based refractory material comprises alumino-silicate ceramic fibers, and wherein the ceramic fiber-based refractory material is in the form of one of a paper or a felt.

14. The composition of claim 11, further comprising:
one or more interfacial materials, wherein one of the following is true for one of the one or more interfacial materials:
(i) the interfacial material is positioned between the intumescent layer and the ceramic fiber-base refractory layer; and
(ii) the interfacial material is positioned between the ceramic fiber-based refractory layer and a metallic surface, and
wherein the one of the one or more interfacial materials comprises one of a layer of air, an adhesive layer, a grease layer, an interfacial metal layer, an interfacial intumescent layer, an interfacial refractory layer, or combination or mixture thereof.

15. The composition of claim 1, wherein the acid catalyst comprises ammonium phosphate.

16. A composition, comprising:
an intumescent layer having a reinforcement material; and
a ceramic refractory layer, wherein the intumescent layer and the ceramic refractory layer are positioned one-on-top of the other.

17. The composition of claim 16, wherein the intumescent layer comprising an epoxy resin and an acid catalyst, wherein the acid catalyst comprises ammonium phosphate.

18. The composition of claim 16, wherein the ceramic refractory material comprises alumino-silicate ceramic fibers, and wherein the ceramic refractory material is in the form of one of a paper or a felt.

19. The composition of claim 16, wherein the reinforcement material is in the form of a mesh.

20. The composition of claim 16, further comprising:
one or more interfacial materials, wherein one of the following is true for one of the one or more interfacial materials:
(i) the interfacial material is positioned between the intumescent layer and the ceramic refractory layer; and
(ii) the interfacial material is positioned between the ceramic refractory layer and a metallic surface, and
wherein the one of the one or more interfacial materials comprises one of a layer of air, an adhesive layer, a grease layer, an interfacial metal layer, an interfacial intumescent layer, an interfacial refractory layer, or combination or mixture thereof.
